(19) United States
(12) Patent Application Publication
(10) Pub. No.: US 2015/0147683 A1
(43) Pub. Date: May 28, 2015

(54) NON-HUMIDIFIED FUEL CELL

(71) Applicant: Hyundai Motor Company, Seoul (KR)

(72) Inventor: Hee Sung Park, Yongin (KR)

(73) Assignee: Hyundai Motor Company, Seoul (KR)

(21) Appl. No.: 14/265,858

(22) Filed: Apr. 30, 2014

(30) Foreign Application Priority Data
Nov. 25, 2013 (KR) 10-2013-0143474

(51) Int. Cl. H01M 4/86

(52) U.S. Cl. CPC H01M 4/8605
USPC 429/530; 429/534

(57) ABSTRACT

A nonhumidified fuel cell is provided that includes a catalytic layer coupled to an anode or a cathode that is configured to accelerate an electrochemical reaction of a fuel gas or air, and a gas diffusion layer that has air pores diffusing the fuel gas or air to the catalytic layer and diffusing water generated by the electrochemical reaction with the fuel gas in the catalytic layer. In particular, a ratio of a volume of water to a volume of air pores of the gas diffusion layer ranges from about 0.1 to 0.4.

### CROSS REFERENCE TO RELATED APPLICATION

The present application claims priority of Korean Patent Application Number 10-2013-0143474 filed on Nov. 25, 2013, the entire contents of which is incorporated herein for all purposes by this reference.

### BACKGROUND

1. Technical Field

The present invention relates to a non-humidified fuel cell having enhanced operational performance.

2. Description of the Related Art

A fuel cell is an electric power generation system that directly converts chemical reaction energy typically between hydrogen and oxygen contained in a hydrocarbon-based material such as methanol, ethanol, or a natural gas into electrical energy.

Fuel cells are often classified as phosphoric acid fuel cells, molten carbonate fuel cells, solid oxide fuel cells, polymer electrolyte membrane fuel cells (PEMFC), or alkaline fuel cells, and the like according to the type of electrolytes that are used. The fuel cells generally have the same overall operational principles and are different only in terms of the type of fuel, operational temperature, catalyst, electrolyte, and the like, that are used. For example, PEMFCs have an excellent output performance and a low operating temperature. This allows for a vehicle to start quickly and have good response characteristics as well as having an extensive application range, relative to other fuel cells.

In a fuel cell system, a fuel cell stack that substantially generates electric power has a structure in which unit cells each including a membrane/electrode assembly (MEA) and a separator having a gas flow path formed therein are stacked. The MEA has a structure in which an anode electrode and a cathode electrode are attached with a high polymer electrolyte membrane interposed therebetween. Additionally, a single electrolyte membrane and two electrodes, a catalytic layer, and a gas diffusion layer are stacked in the MEA.

When hydrogen is supplied to the anode, electrochemical oxidation reaction takes place, which ionizes hydrogen into hydrogen ions and electrons to be oxidized. The ionized hydrogen ions move toward the cathode through the high polymer electrolyte membrane, and the electrons move toward the cathode through an external circuit. The hydrogen ions which are moving toward the cathode cause an electrochemical reduction reaction with oxygen supplied to the cathode to produce heat and water, and the movement of electrons produces electrical energy.

A gas diffusion layer (GDL) may be made up of a plurality of air pores to diffuse a fuel cell reaction gas toward the catalytic layer. The catalytic layer on the anode side separates hydrogen molecules into hydrogen atoms, and decomposes the hydrogen atoms into hydrogen ions and electrons. Conversely, catalytic layer on the cathode side separates oxygen molecules in the air into atoms and ionizes the same. As such, the GDL is formed by stacking a plurality of fibers and placed between the separator and the electrode/catalytic layer. The GDL may be composed of a solid (e.g., serving for electrical conduction) and air pores (e.g., serving to diffuse gas and water). For example, cathon paper, carbon cloth, cathon felt, graphite paper, graphite woven fabrics, and the like, may be used as the GDL.

Also, the GDL serves to discharge water generated in an electrochemical reaction of the fuel cell to the outside. Namely, the GDL provides a movement path to allow a fed gas to be evenly delivered to the catalytic layer and used as a discharge passage for water generated in the catalytic layer during operation. In order to prevent supplied/generated gaseous water from being condensed on a surface of the GDL, the GDL may be water-repellent treated with polytetrafluoroethylene (PTEE), or the like, so as to be used.

However, in these types of fuel cells when a humidification fails thus resulting in a non-humidified fuel cell, a hydrophobic GDL lowers humidity of the catalytic layer to drastically reduce electrical conductivity of the membrane electrode and sharply reduce electric power generation efficiency of the fuel cell. Thus, a fuel cell which does not require humidification would be beneficial to ensure consistent power generation efficiency and conductivity.

The matters described as a background art merely promote understanding of the background of the present invention and may not be admitted as corresponding to the related art already known to a person skilled in the art.

### SUMMARY

An object of the present invention is to provide a fuel cell in which a liquid within a fuel cell stack is maintained for an optimal electrochemical reaction by adjusting hydrophilicity and hydrophobicity of a gas diffusion layer.

According to an exemplary embodiment of the present invention, there is provided a fuel cell including: a catalytic layer coupled to an anode or a cathode, the catalytic layer configured to accelerate an electrochemical reaction of a fuel gas or air; and a gas diffusion layer having air pores configured to diffuse the fuel gas or air to the catalytic layer and diffuse water generated by the electrochemical reaction with the fuel gas in the catalytic layer, wherein a ratio of a volume of water to a volume of air pores of the gas diffusion layer ranges from about 0.1 to 0.4.

In some exemplary embodiments, the gas diffusion layer may have a hydrophobic coating layer in which water is not condensed on a surface of the gas diffusion layer, and a portion of a surface of the gas diffusion layer may be a hydrophilic surface in a region of the hydrophobic coating layer in which defects are generated. Additionally, a portion of the surface of the gas diffusion layer may be a hydrophilic surface in a region in which defects are generated.

The defects of the hydrophobic coating layer in the exemplary embodiments of the present invention may be generated during a coating process of the coating layer, and the coating layer may be coated at different coating mass ratios according to desired defect distributions. For example, a ratio of the hydrophilic surface to the entire surface area of the gas diffusion layer may be equal to a ratio of the volume of water to the volume of the air pores of the gas diffusion layer. These defects may be randomly distributed over the entire surface of the gas diffusion layer, for example, they may be concentrated on the catalytic layer in the entire surface of the gas diffusion layer, or they may be concentrated on the opposite side of the catalytic layer over the entire surface of the gas diffusion layer.

In some exemplary embodiments, the coating layer may be formed by dipping the gas diffusion layer or may be formed through plasma coating, spray coating, screen coating, or inkjet coating. A coating material of the coating layer may be or example PTFE (Polytetrafluoroethylene), carbon nano-tube, carbon nano-particle, or an organic or inorganic solvent.

### BRIEF DESCRIPTION OF THE DRAWINGS

FIG. 1A is a diagram showing a formation of a hydrophilic surface due to a defective surface of a gas diffusion layer in the exemplary embodiments of the present invention;

FIG. 1B is a diagram showing a formation of a hydrophilic surface due to a defective coating layer in the exemplary embodiments of the present invention;

FIG. 2 is a graphical illustration showing a relationship among liquid saturation, current density and voltage in operating a non-humidified fuel cell according to the exemplary embodiments of the present invention; and

FIGS. 3A-3C are diagrams showing dispositions within a fuel cell according to each of exemplary embodiments of the present invention.

### DESCRIPTION OF THE EXEMPLARY EMBODIMENTS

Hereinafter, exemplary embodiments of the present invention will be described in detail with reference to the accompanying drawings. The like numbers refer to like elements in the drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid fuel cell vehicles, electric fuel cell vehicles, plug-in hybrid electric fuel cell vehicles, hydrogen-powered fuel cell vehicles, and other alternative fuel cell vehicles. As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.

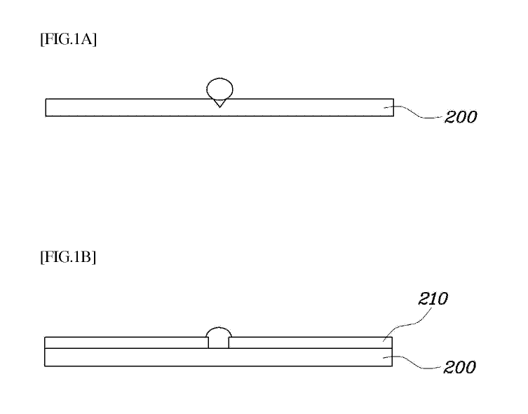

FIG. 1A is a diagram showing a formation of a hydrophilic surface due to a defective surface of a gas diffusion layer, and FIG. 1B is a diagram showing a formation of a hydrophilic surface due to a defective coating layer. In particular, a fuel cell according to an exemplary embodiment of the present invention may include a catalytic layer coupled to an anode and a cathode in a manner that is configured to accelerate an electrochemical reaction of a fuel gas or air, and a gas diffusion layer having air pores diffusing a fuel gas or air to the catalytic layer and diffusing water produced by an electrochemical reaction with the fuel gas in the catalytic layer.

The gas diffusion layer may be a hydrophobic gas diffusion layer, and the hydrophobic gas diffusion layer may be coated with a hydrophobic coating layer to prevent water from being condensed on a surface thereof. Additionally, a hydrophilic surface of the gas diffusion layer may be exposed to a region of the gas diffusion layer in which the hydrophobic coating layer is defective or to a region in which a surface of the gas diffusion layer is defective.

Namely, in the exemplary fuel cell of the exemplary embodiments of the present invention, the characteristics of the gas diffusion layer are maintained as hydrophobicity on the whole, but hydrophilicity may be maintained within portion in the defective regions by using a defect (FIG. 1B) generated during a coating process, a defect (FIG. 1A) generated during manufacturing of a fabric material of the gas diffusion layer, and the like.

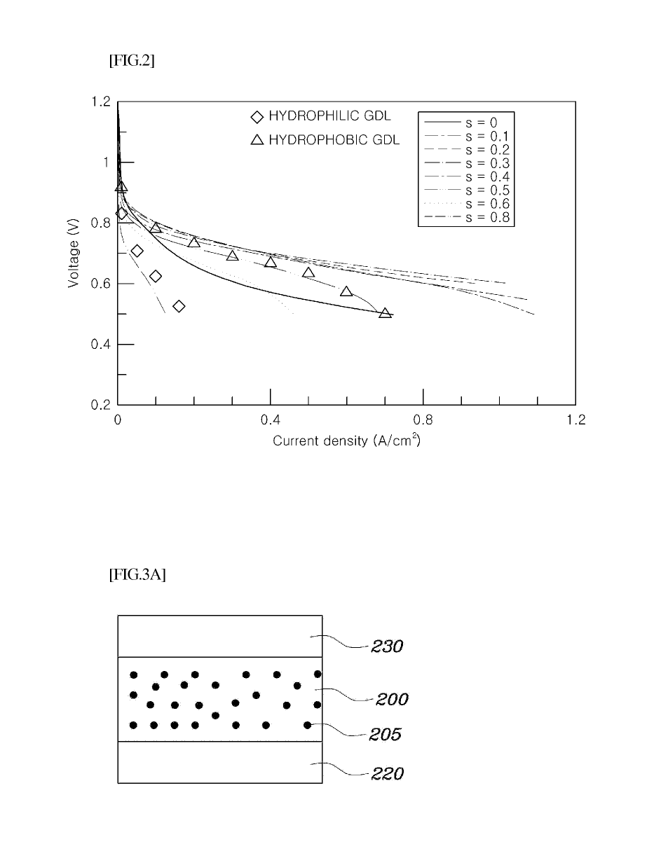

FIG. 2 is a graph showing a relationship among liquid saturation, current density and voltage in operating a non-humidified fuel cell. A core technology in the method of using a defect generated during a coating process or in manufacturing a fabric material is how a degree a distribution of the hydrophilic surface is to be maintained. FIG. 2 is a graph showing the results obtained by testing a gas diffusion layer 200 in the same fuel cell, while changing a saturation ratio.

As can be seen from FIG. 2, in a non-humidified state, the amount of water in the gas diffusion layer and the catalytic layer is insufficient. Thus, as the hydrophilic characteristics increase, electrical resistance of the electrolyte membrane is reduced, thereby obtaining higher electrical energy.

A liquid saturation ratio (s) is a ratio of volume Vw of a liquid to a pore volume Vp of a porous material constituting the gas diffusion layer 200. Namely, the liquid saturation ratio may be expressed as Vw/Vp. As can be seen in the graph, when the liquid saturation ratio is about 0.1<s<0.4, the fuel cell has good generation performance Here, the liquid saturation ratio may be equal to a ratio of a hydrophilic surface to the entire surface of the gas diffusion layer 200. Thus, when the ratio of a volume of water to a volume of the air pores of the gas diffusion layer 200 ranges from about 0.1 to 0.4, generation performance of the fuel cell is maximized. Namely, the ratio of the hydrophilic surface over the entire surface area of the gas diffusion layer 200 may be equal to a ratio of the volume of water to the volume of the air pores of the gas diffusion layer 200.

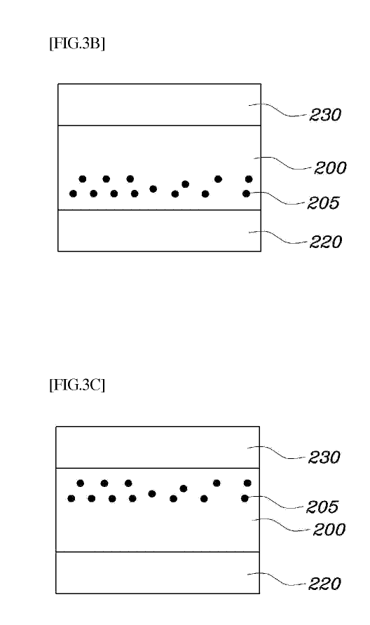

FIGS. 3A through 3C are diagrams showing dispositions within a fuel cell according to each of exemplary embodiments of the present invention. Black circles in FIGS. 3A through 3C denote defects generated on the surface of the gas diffusion layer 200. The gas diffusion layer 200 may be positioned between a catalytic layer 220 and a gas channel layer (or a separator) 230. A hydrophobic coating layer may be disposed on a surface of the gas diffusion layer 200. A defect of a hydrophobic coating layer 210 as such may generated during a coating process of the coating layer 210, and the coating layer 210 may be formed in different coating mass ratios according to desired defect distributions.

More specifically, defects 205 in FIG. 3A may be randomly distributed on the entire surface of the gas diffusion layer 200, and defects 205 in FIG. 3B may be concentrated on the catalytic layer 220 side over the entire surface of the gas diffusion layer 200. Defects 205 in FIG. 3C may also be concentrated on the opposite side of the catalytic layer 220, namely, on the gas channel layer 230 side, over the entire surface of the gas diffusion layer 200.

The defects 205 may be defects present on the surface of the gas diffusion layer 200 or may be defects that may be generated during a coating process. A hydrophilic surface may be exposed from the surface of the gas diffusion layer 200 due to the defects 205. Accordingly, a hydrophilicity ratio may be determined according to the exposed hydrophilic surface, and the fuel cell may have a high generation performance when the hydrophilicity ratio ranges from about 0.1 to 0.4 as mentioned above.

The coating layer 210 may be formed by dipping the gas diffusion layer 200 or may be formed through plasma coating, spray coating, screen coating, or inkjet coating, and here, a coating to material of the coating layer 210 may be FIFE (Polytetrafluoroethylene), cathon nano-tube, cathon nano-particle, or an organic or inorganic solvent.

In order to implement a hydrophilic surface on the surface of the hydrophobic gas diffusion layer, defects on the surface of the gas diffusion layer may be used or a gas diffusion layer having a different ratio of hydrophobicity coating may be used according to requested characteristics of FIGS. 3B and 3C by using the hydrophobicity coating mass ratio of the coating layer to the gas diffusion layer. Namely, in the case of FIG. 3B, the gas diffusion layer 200 at the catalytic layer 220 side has a lower coating ratio, having a high possibility of defect. In the case of FIG. 3C, the gas diffusion layer 200 at the gas channel layer 230 side has a lower coating ratio, having a high possibility of defect as well. Namely, a position of the defect distribution in the gas diffusion layer 200 may be adjusted by the above method accordingly.

With the fuel cell according to the exemplary embodiment of the present invention having the structure as described above, advantageously has a higher electrical energy that can be obtained even in a non-humidified state by adjusting a saturation percentage of a gas diffusion layer. In detail, performance of approximately 100% may be enhanced, relative to an indefective hydrophobic gas diffusion layer. In addition, by implementing a fuel cell system to be non-humidified, a weight and volume of a humidifier in an existing system can be reduced, and performance and price competitiveness of a humidifier can be increased by lowering unit cost as much as cost thereof.

Although the present invention has been shown and described with respect to specific exemplary embodiments, it will be obvious to those skilled in the art that the present invention may be variously modified and altered without departing from the spirit and scope of the present to invention as defined by the following claims.

What is claimed is:

1. A fuel cell comprising:
a catalytic layer coupled to an anode or a cathode and configured in a manner to accelerate an electrochemical reaction of a fuel gas or air; and
a gas diffusion layer having air pores configured to diffuse the fuel gas or air to the catalytic layer and configured to diffuse water generated by the electrochemical reaction with the fuel gas in the catalytic layer,
wherein a ratio of a volume of water to a volume of air pores of the gas diffusion layer ranges from about 0.1 to 0.4.

2. The fuel cell of claim 1, wherein the gas diffusion layer has a hydrophobic coating layer in which water is not condensed on a surface of the gas diffusion layer, and a portion of the surface of the gas diffusion layer is a hydrophilic surface in a region of the hydrophobic coating layer in which defects are generated.

3. The fuel cell of claim 1, wherein a portion of a surface of the gas diffusion layer is a hydrophilic surface in a region in which defects are generated.

4. The fuel cell of claim 2, wherein the defects of the hydrophobic coating layer are generated during a coating process of the coating layer, and the coating layer is coated at different coating mass ratios according to desired defect distributions.

5. The fuel cell of claim 2, wherein a ratio of the hydrophilic surface to an entire surface area of the gas diffusion layer is equal to a ratio of a volume of water to a volume of the air pores of the gas diffusion layer.

6. The fuel cell of claim 2, wherein the defects are randomly distributed over the entire surface of the gas diffusion layer.

7. The fuel cell of claim 2, wherein the defects are concentrated on the catalytic layer over the entire surface of the gas diffusion layer.

8. The fuel cell of claim 2, wherein the defects are concentrated on the opposite side of the catalytic layer over the entire surface of the gas diffusion layer.

9. The fuel cell of claim 2, wherein the coating layer is formed by dipping the gas diffusion layer or is formed through at least one selected from a group consisting of plasma coating, spray coating, screen coating, and inkjet coating.

10. The fuel cell of claim 2, wherein a coating material of the coating layer is selected from at a group consisting of PTFE (Polytetrafluoroethylene), carbon nano-tube, carbon nano-particle, and an organic or inorganic solvent.
